(19) United States
(12) Patent Application Publication
(10) Pub. No.: US 2012/0296878 A1
(43) Pub. Date: Nov. 22, 2012

(54) FILE SET CONSISTENCY VERIFICATION SYSTEM, FILE SET CONSISTENCY VERIFICATION METHOD, AND FILE SET CONSISTENCY VERIFICATION PROGRAM

(75) Inventors: Masayuki Nakae, Tokyo (JP); Yuki Ashino, Tokyo (JP)

(73) Assignee: NEC Corporation, Tokyo (JP)

(21) Appl. No.: 13/519,478

(22) PCT Filed: Jan. 12, 2011
(86) PCT No.: PCT/JP2011/000079

§ 371 Date: Jun. 27, 2012

(30) Foreign Application Priority Data
Jan. 21, 2010 (JP) 2010-010671

(51) Int. Cl. G06F 17/30

(52) U.S. Cl. 707/690; 707/E17.005

(57) ABSTRACT

A check code generating means 10 generates, based on metadata of files satisfying a designated condition, a first check code uniquely representing a characteristic of a first file set whose components are files satisfying the condition. Moreover, the check code generating means 10 generates, based on metadata of files satisfying the condition, a second check code uniquely representing a characteristic of a second file set whose components are files satisfying the condition. An inconsistency detecting means 20 compares the first check code and the second check code and, based on inconsistency between the check codes, detecting inconsistency between the first file set and the second file set.

### TECHNICAL FIELD

The present invention relates to a file set consistency verification technique for verifying consistency between file sets, more specifically, relates to a file set consistency verification technique by which it is possible to rapidly verify that two file sets of huge data amounts are different.

### BACKGROUND ART

Current computer systems are often required to determine whether a file set at a verification moment is consistent with a file set at a reference moment that is earlier than the verification moment (whether a corresponding file set has been updated or not), for example, in file falsification check for security, verification of a disk status for backup and restore operations, and check of a dependent file for distribution of application software and patch.

Such consistency verification can be easily realized by comparing and checking the contents of corresponding files bit-by-bit or byte-by-byte between the file set at the reference moment and the file set at the verification moment.

However, as capacities of secondary storage devices have become larger in recent years, there are more occasions to handle a file set as huge as hundreds of gigabytes such as a binary file set like kernel library configuring an operating system (OS) and a sound and moving picture file set, and there is a problem that it takes long time (tens of minutes to several hours) to verify consistency between huge file sets by the aforementioned obvious method.

As a rapid consistency verification technique disclosed heretofore, there is a technique using a “hash value” described in Patent Document 1. A hash value is a value obtained by executing an operation by a hash function on data, and is characterized by having a constant length (in general, about 128 to 512 bits) at all times regardless of the size of original data and becoming a different value when original data is different. In the technique described in Patent Document 1, consistency is verified by calculating and recording a hash value for the whole data recorded on a logical disk at a reference moment and comparing the recorded hash value with a hash value calculated at a verification moment. Because the hash value is extremely smaller than the size of the logical disk, it is possible to make a time required for the comparison process extremely short. Moreover, in the technique described in Patent Document 1, for the purpose of shortening a time required for the process of calculating the hash value, the logical disk is divided into segments of fixed lengths, and a plurality of first hash value calculating means that can operate in parallel and a second hash value calculating means are provided. Thus, the first hash value calculating means each calculates a hash value of a segment allocated to the means itself in parallel and, based on the hash values of the respective segments calculated by the first hash value calculating means, the second hash value calculating means calculates the hash value of the whole logical disk.

Further, as another rapid consistency verification technique, a method using a “native data signature” is disclosed in Patent Document 2. A native data signature is generated based on time of change of a file, a history of changing operations, and the like. A native data signature is data of a fixed length corresponding to the number of changes (the version number) of a file, and a size thereof is much smaller than a data stream of a file. In the technique described in Patent Document 2, after a first file including a data stream is stored into a disk device, a first native data signature that uniquely corresponds to the data stream is generated and incorporated into the first file. Moreover, when a second file as a result of making a change to the data stream of the first file is written back into the disk device, a second native data signature that uniquely corresponds to a data stream in the second file is generated and incorporated into the second file. For verifying consistency between the data stream of the first file and the data stream of the second file, the first native data signature incorporated in the first file and the second native data signature incorporated in the second file are compared.

[Patent Document 1] Japanese Unexamined Patent Application Publication No. 2007-257566

[Patent Document 2] Japanese Patent Publication No. 4283440

In the technique described in Patent Document 1, because consistency is verified by comparing hash values, it is possible to make a time required for the comparison process extremely shorter than when comparing data bit-by-bit or byte-by-byte. Moreover, in the process of calculating a hash value, the hash value is calculated by using a plurality of hash value calculating means that can perform in parallel, so that it is possible to make a time required for the hash value calculation process shorter than when calculating a hash value by using one hash value calculating means. However, in the technique described in Patent Document 1, hash values are calculated with respect to the whole data on which consistency verification is executed. Therefore, even if a plurality of hash value calculating means that can operate in parallel are used for calculating hash values, in a case that the size of data on which consistency verification is executed is large, much time is spent for calculation of hash values, and a time required for the consistency verification process becomes long.

Further, in the technique described in Patent Document 2, because it is possible to verify consistency between the first file and the second file by comparing the native data signature incorporated in the first file and the native data signature incorporated in the second file, it is possible to make a time required for the comparison process extremely shorter than when comparing the contents of files bit-by-bit or byte-by-byte. However, in the technique described in Patent Document 2, it is necessary to perform a process of supervising a file update operation at all times, and a process of, when a file as a result of making a change to a data stream is written back into a disk device (a secondary storage device), incorporating a native data signature that uniquely corresponds to the data stream of the file into the file. Because such a process is an additional process that is not executed in a general OS file output process, there is a problem that file output processing performance in a routine operation of a computer system is degraded due to the process of supervising a file update operation and the process of incorporating a native data signature into a file.

### SUMMARY

Accordingly, an object of the present invention is to provide a file set consistency verification system solving a problem that it requires long time to perform a consistency verification process when the size of a file set to be subjected to consistency verification is large, and a problem that routine file output processing performance is degraded due to the consistency verification process.

A file set consistency verification system includes:

a check code generating means for, regarding a first file set configured by files satisfying a designated condition, generating a first check code uniquely representing a characteristic of the first file set based on metadata of the files belonging to the first file set at a reference moment and, regarding a second file set configured by files satisfying the condition, generating a second check code uniquely representing a characteristic of the second file set based on metadata of the files belonging to the second file set; and an inconsistency detecting means for comparing the first check code and the second check code and, based on inconsistency between the check codes, detecting inconsistency between the first file set and the second file set.

A file set consistency verification method according to another exemplary embodiment of the present invention includes:

regarding a first file set configured by files satisfying a designated condition, generating a first check code uniquely representing a characteristic of the first file set based on metadata of the files belonging to the first file set at a reference moment, by a check code generating means;

regarding a second file set configured by files satisfying the condition, generating a second check code uniquely representing a characteristic of the second file set based on metadata of the files belonging to the second file set at a verification moment at or after the reference moment, by the check code generating means; and

detecting inconsistency between the first file set and the second file set based on inconsistency between the first check code and the second check code, by an inconsistency detecting means.

A computer-readable recording medium storing a file set consistency verification program according to another exemplary embodiment of the present invention is a computer-readable recording medium storing a file set consistency verification program for causing a computer to function as a file set consistency verification system, and stores the program comprising instructions for causing the computer function as:

a check code generating means for, regarding a first file set configured by files satisfying a designated condition, generating a first check code uniquely representing a characteristic of the first file set based on metadata of the files belonging to the first file set at a reference moment and, regarding a second file set configured by files satisfying the condition, generating a second check code uniquely representing a characteristic of the second file set based on metadata of the files belonging to the second file set at a verification moment at or after the reference moment; and

an inconsistency detecting means for comparing the first check code and the second check code and, based on inconsistency between the check codes, detecting inconsistency between the first file set and the second file set.

According to the present invention, it is possible to obtain an effect that a time required for a process of verifying consistency between file sets can be shortened without adversely affecting on file output performance in a routine operation of a computer system even when the sizes of the file sets to be subjected to consistency verification are large.

### BRIEF DESCRIPTION OF DRAWINGS

FIG. 1 is a block diagram showing an example of a configuration of a first exemplary embodiment of the present invention;

FIG. 2 is a flowchart showing an example of a process of the first exemplary embodiment of the present invention;

FIG. 3 is a block diagram showing an example of a configuration of a second exemplary embodiment of the present invention;

FIG. 4 is a flowchart showing an example of a process of the second exemplary embodiment of the present invention;

FIG. 5 is a view showing an example of arrangement of metadata in a secondary storage device;

FIG. 6 is a view showing an example of a method of distributing differential data, a fingerprint and a file name list in the second exemplary embodiment of the present invention;

FIG. 7 is a view showing another example of a method of distributing differential data, a fingerprint and a file name list in the second exemplary embodiment of the present invention;

FIG. 8 is a block diagram showing an example of a configuration of a third exemplary embodiment of the present invention;

FIG. 9 is a flowchart showing an example of a process of the third exemplary embodiment of the present invention;

FIG. 10 is a block diagram showing a modified example of the third exemplary embodiment of the present invention;

FIG. 11 is a view showing an example of a directed graph representing a dependency relation in the third exemplary embodiment of the present invention;

FIG. 12 is a view showing an example of a method of generating a fingerprint;

FIG. 13 is a view showing another example of a method of generating a fingerprint;

FIG. 14 is still another example of a method of generating a fingerprint; and

FIG. 15 is a block diagram showing an example of a configuration of a fourth exemplary embodiment of the present invention.

### EXEMPLARY EMBODIMENTS

Next, exemplary embodiments of the present invention will be described in detail with reference to the drawings.

### First Exemplary Embodiment of Present Invention

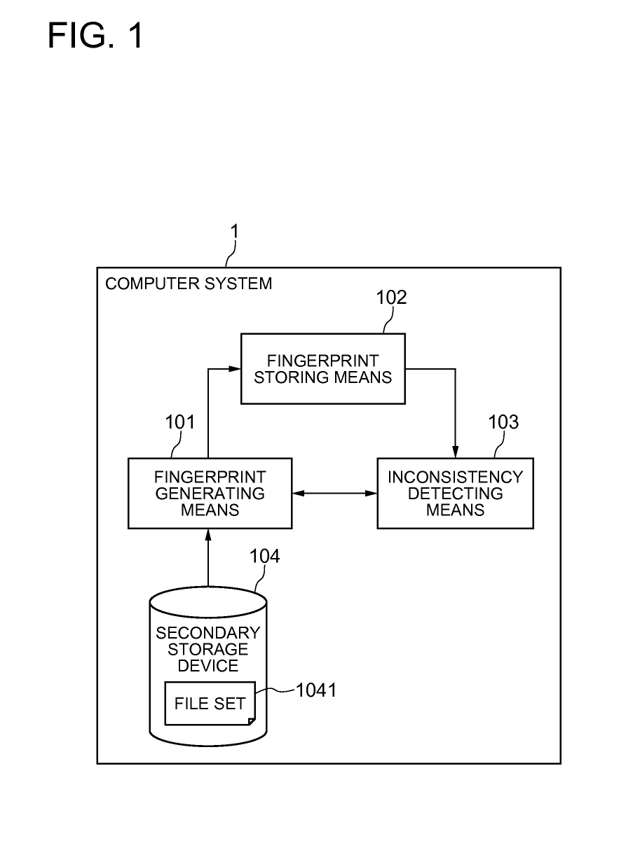

With reference to FIG. 1, in a first exemplary embodiment of the present invention, a computer system 1 operating under program control includes a fingerprint generating means 101, a fingerprint storing means 102, an inconsistency detecting means 103, and a secondary storage device 104.

The fingerprint generating means 101 functions as a check code generating means. When a fingerprint generation instruction including a condition that files configuring a file set 1041 to be subjected to consistency verification should satisfy is inputted by a user, the fingerprint generating means 101 retrieves metadata of the respective files satisfying the abovementioned condition from the secondary storage device 104, and generates a fingerprint (a check code) FP1 unique to the file set 1041 based on these metadata. Then, the fingerprint generating means 101 records the generated fingerprint FP1 as a fingerprint at a reference moment into the fingerprint storing means 102, and also records the condition included in the fingerprint generation instruction into the fingerprint storing means 102. Moreover, when a fingerprint generation instruction is inputted from the inconsistency detecting means 103, the fingerprint generating means 101 generates a fingerprint FP2 for the file set 1041 whose components are files satisfying the condition included in this instruction, and returns the generated fingerprint FP2 as a fingerprint at a verification moment to the inconsistency detecting means 103. As a condition included in a fingerprint generation instruction, it is possible to use, for example, a file name list in which file names of files included in a file set to be subjected to consistency verification are listed, a creation time and date list in which creation dates and times of files included in a file set to be subjected to consistency verification are listed, or the like. In the following description, a case of using a file name list will be described as an example.

When a verification instruction is inputted by the user, the inconsistency detecting means 103 retrieves a file name list from the fingerprint storing means 102, and outputs a fingerprint generation instruction including this file name list to the fingerprint generating means 101. When the fingerprint FP2 at the verification moment is returned from the fingerprint generating means 101 in response to the fingerprint generation instruction, the inconsistency detecting means 103 compares the fingerprint FP2 with the fingerprint FP1 at the reference moment recorded in the fingerprint storing means 102. When the fingerprints FP1 and FP2 do not coincide, the inconsistency detecting means 103 informs the user that the file sets subjected to the verification are in the inconsistent state.

The fingerprint generating means 101 and the inconsistency detecting means 103 can be realized by a computer, and are realized by a computer in the following manner, for example. A disk on which a program for causing a computer to function as the fingerprint generating means 101 and the inconsistency detecting means 103 is recorded, a semiconductor memory, and another recording medium are prepared, and the computer is caused to load the program. The computer controls its own operation in accordance with the loaded program, and thereby realizes the fingerprint generating means 101 and the inconsistency detecting means 103 on the computer itself.

### Description of Operation of First Exemplary Embodiment

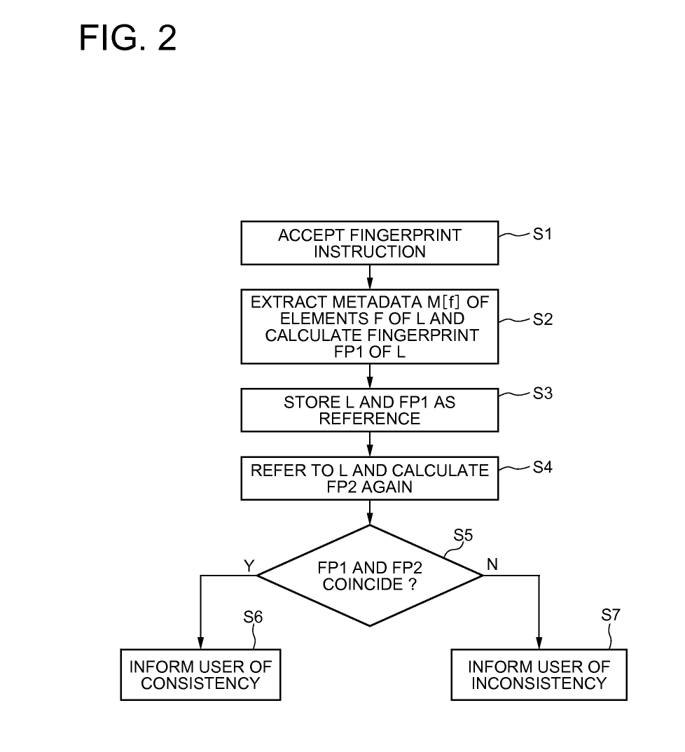

Next, an entire operation of this exemplary embodiment will be described in detail with reference to FIG. 1 and a flowchart of FIG. 2.

Firstly, the user inputs a fingerprint generation instruction into the fingerprint generating means 101 through an inputting means such as a keyboard, which is not illustrated in the drawings. This fingerprint generation instruction includes a file name list L. The file name list L is a list whose elements are file names, and the file names of the respective files configuring the file set 1041 to be subjected to consistency verification are listed therein. To be specific, in the file name list L, the file names of the respective files configuring the file set 1041, such as the file names of binary files of OS kernel, library and an application and the file names of files storing important data, are listed. In the following description, it is assumed that file names f1 to fN are listed in the file name list L. Moreover, in the following description, a file with a file name f may be simply referred to as a file f.

The fingerprint generating means 101 accepts the fingerprint generation instruction inputted by the user (step S1 of FIG. 2). Next, regarding the respective elements f1 to fN of the file name list L included in the fingerprint generation instruction, the fingerprint generating means 101 retrieves metadata M[f1] to M[fN] corresponding to the elements fl to fN from the secondary storage device 104. Moreover, the fingerprint generating means 101 generates the fingerprint FP1 for the file set 1041 whose components are the files with the file names listed in the file name list L, based on the retrieved metadata M[f1] to M[fN] (step S2). Here, metadata M[f] is a secondary attribute of the file f including the file name, timestamp, file size, etc., of the file f, and is a data set that does not include the content of the file f.

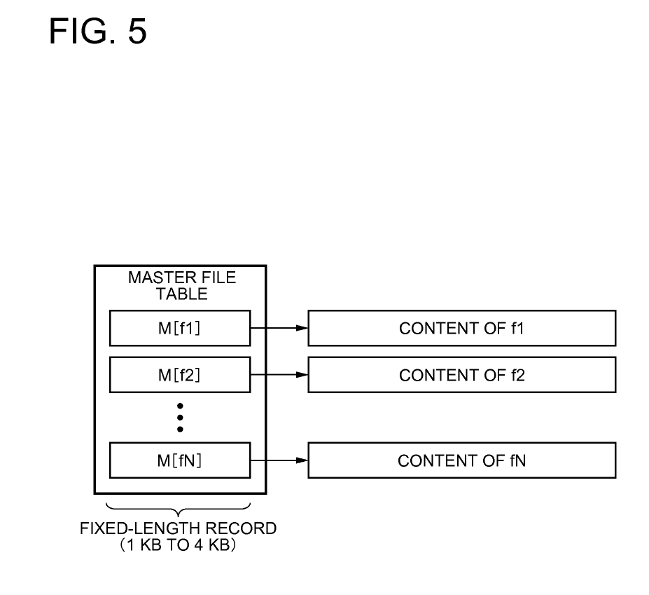

In a file system of a general OS, metadata M[f] is data stored in a specific region of the secondary storage device 104, and is data of extremely small size as compared with the data length of the content of the file f. For example, in the file system (NTFS) of Windows OS, metadata M[f] corresponding to any file f is stored as a fixed-length record of 4 KB or less in a region called a MFT (master file table) (refer to FIG. 5). Moreover, the fingerprint generating means 101 can acquire information on the file names, timestamps and file sizes stored in all of the metadata by scanning the MFT from the beginning thereof once.

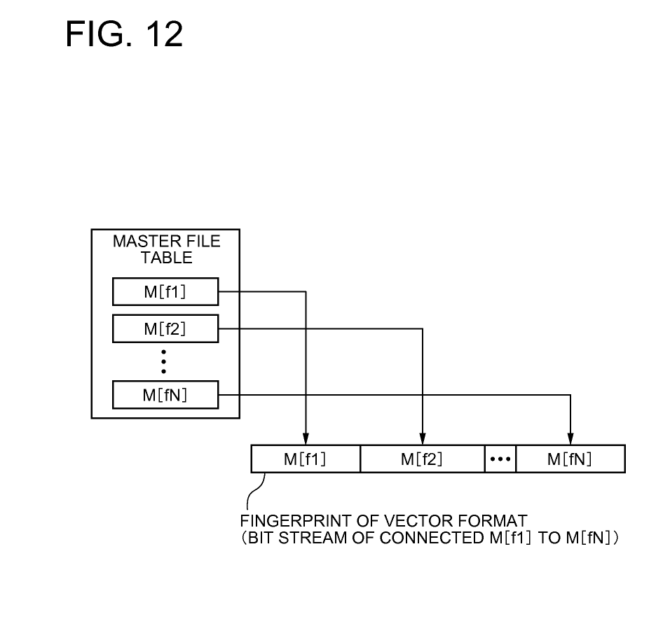

A method for generating a fingerprint from the metadata M[f1] to M[fN] may be any method as far as, when any content of the file f1 to fN is updated, a fingerprint value before the update is different from a fingerprint value after the update. One example is generating a vector in which the metadata M[f1] to M[fN] are connected so that the file names included therein are arranged in the dictionary order (refer to FIG. 12). In a case that any content of the files f1 to fN is updated, any value in the metadata M[f1] to M[fN] (e.g., a timestamp, a file size) changes, so that the value of the vector (the fingerprint) in which the metadata M[f1] to M[fN] are connected also becomes a different value from a value before the update.

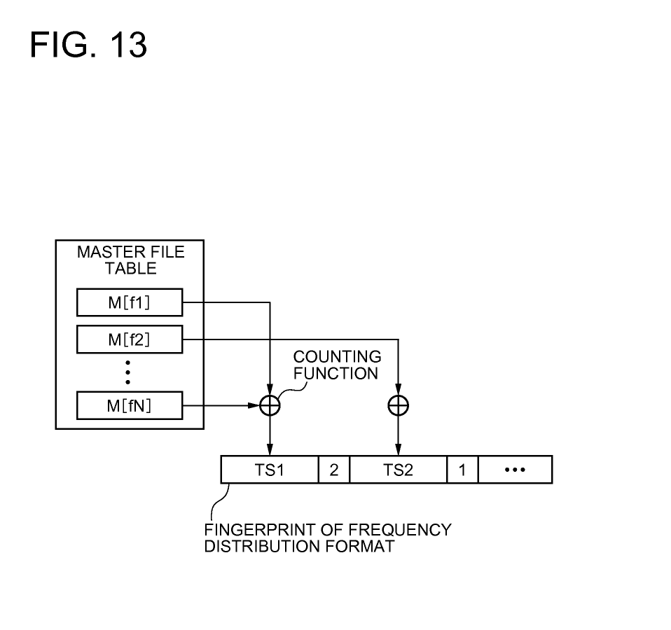

In order to shorten a time required for a process of comparing fingerprints described later, it is desirable that the data size of a fingerprint is small. To be specific, a statistic regarding part of the attribute values of the metadata M[f1] to M[fN] is calculated and used as a fingerprint. For example, as a statistic regarding part of the attribute values included in the metadata M[f1] to M[fN], a common timestamp value and the number of appearance thereof may be calculated and used as a fingerprint (refer to FIG. 13). An example of FIG. 13 shows that the number of metadata including a timestamp “TS1” is two and the number of metadata including a timestamp “TS2” is one. Moreover, in order to obtain a higher accuracy of consistency verification, regarding a pair of a timestamp and a file size, a pair of a common timestamp and file size and the number of appearance thereof may be calculated and used as a fingerprint. In any method of generating a fingerprint by using a statistic of part of the attribute values of metadata, it is possible to generate fingerprints whose values are different between before the update of the file and after the update of the file because of the aforementioned reason. Moreover, because only part of the attribute values of metadata is used, the data size is smaller than in the aforementioned method of connecting the metadata M[f1] to M[fN] as a bit string, and a time required for a process of comparing fingerprints described later is shortened.

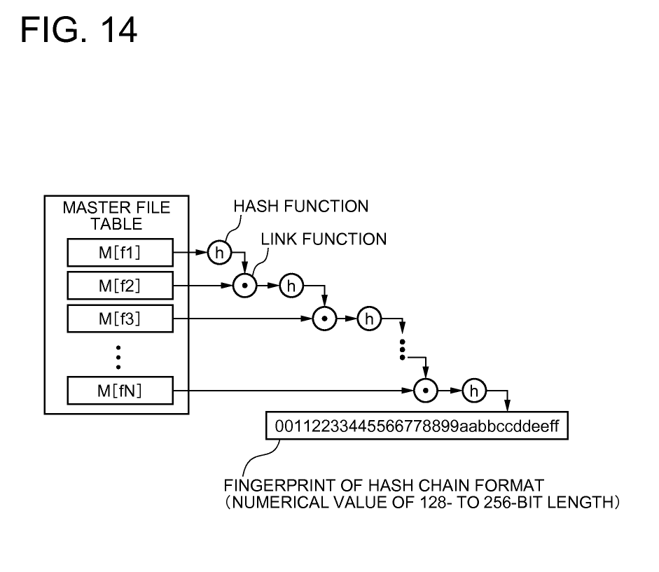

Another preferable example is calculating a hash chain for the metadata M[f1] to M[fN] and using as a fingerprint. That is to say, for “M[f1], M[f2], . . . , M[fN]” in which the metadata M[f1] to M[fN] are arranged so that the file names included therein are in the dictionary order, a hash chain “h(M[fN].h(M[fN−1].h( . . . .h(M[f1]))))” is calculated and used as a fingerprint (refer to FIG. 14). Here, a function h is a hash function like MD5, and has properties that an output value of a fixed length is outputted with respect to an input value of any length and the output value becomes a different value with respect to a different input value with high probability. Moreover, it is also possible to employ a method calculating a hash chain with respect to part of the attribute values included in the metadata M[f1] to M[fN] and using as a fingerprint. For example, for “f1, f2, . . . , fN” in which the file names included in the metadata M[f1] to M[fN] are arranged in the dictionary order, a hash chain “h(fN.h(fN−1.h( . . . .h(f1))))” is calculated and used as a fingerprint. As a result of employing calculating a hash chain and using as a fingerprint, a fingerprint is represented with a fixed length (e.g., 256 bits), and an effect that even if the size of a file content and the number of elements of the file name list L increase, a calculation time required for comparison of fingerprints becomes constant is obtained.

The fingerprint generating means 101 records the fingerprint FP1 generated in the abovementioned manner as a fingerprint at a reference moment into the fingerprint storing means 102, and also records the file name list L included in the fingerprint generation instruction into the fingerprint storing means 102 (step S3). Thus, a process at the reference moment is completed.

After that, when the user wants to execute consistency verification with the reference moment on the content of the file set whose components are the files with the names listed in the file name list L, the user inputs a verification instruction into the inconsistency detecting means 103 through the keyboard that is not illustrated in the drawings.

Consequently, the inconsistency detecting means 103 retrieves the file name list L from the fingerprint storing means 102, and outputs a fingerprint generation instruction including this file name list L to the fingerprint generating means 101. Upon acceptance of this instruction, the fingerprint generating means 101 executes a process like the process mentioned before, thereby generating the fingerprint FP2 at a verification moment and returning the fingerprint FP2 to the inconsistency detecting means 103 (step S4).

Upon acceptance of the fingerprint FP2 at the verification moment, the inconsistency detecting means 103 retrieves the fingerprint FP1 at the reference moment from the fingerprint storing means 102, and compares the fingerprints (step S5). The inconsistency detecting means 103 informs the user that the file set 1041 at the reference moment and the file set 1041 at the verification moment are consistent when the fingerprints coincide (step S6), or informs the user that the file sets 1041 are inconsistent when not coincide (step S7),

### Effect of First Exemplary Embodiment

Next, an effect of this exemplary embodiment will be described.

According to this exemplary embodiment, even when the sizes of file sets to be subjected to consistency verification are large, an effect that it is possible to shorten a time required for a process of consistency verification of the file sets without adversely affecting file output performance in a routine operation of a computer system can be obtained. This is because consistency of file sets is verified by using fingerprints (check codes) generated based on metadata of files configuring the file sets. In a general OS, the size of metadata is several KB to tens of KB, which is extremely smaller than the size of a file. Therefore, by generating a fingerprint based on metadata, it is possible to shorten a time required for a fingerprint generation process, and accordingly, it is possible to shorten a time required for a consistency verification process. Moreover, metadata is recorded into a specified region (e.g., a master file table) of the secondary storage device 104 by a general process executed by a general OS, and it is not necessary to execute a process of supervising a file update operation or a process of writing out a native data signature to the secondary storage device 104, which are not executed in a general OS, so that file output performance in a routine operation of a computer system will not be adversely affected.

Further, in this exemplary embodiment, because a fingerprint is an appearance frequency distribution of part of the attribute values of metadata, it is possible to make the size of a fingerprint smaller, and consequently, it is possible to shorten a time required for a fingerprint comparing process.

Further, in this exemplary embodiment, because a fingerprint is a hash chain regarding at least part of the attribute values of metadata, a fingerprint is fixed-length, and consequently, it is possible to make a time required for a fingerprint comparing process constant regardless of the number and size of tiles included in a file set to be subjected to verification.

### Second Exemplary Embodiment of Present Invention

Next, a second exemplary embodiment of the present invention will be described in detail. In this exemplary embodiment, consistency of file sets is verified at the time of distribution of software from a first computer system to a second computer system.

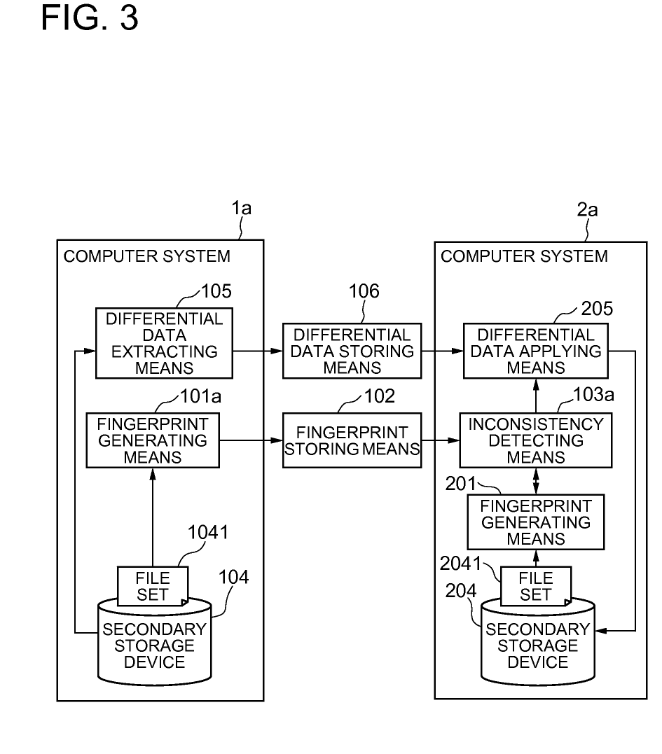

With reference to FIG. 3, the second exemplary embodiment of the present invention is provided with the computer systems 1a and 2a operating under program control.

The computer system 1a is provided with a fingerprint generating means 101a, the secondary storage device 104 and a differential data extracting means 105, and the fingerprint storing means 102 and a differential data storing means 106 are connected thereto.

The fingerprint generating means 101a, in response to a fingerprint generation instruction inputted by the user, scans the metadata of all files stored in the secondary storage device 104, and generates the file name list L in which the file names of the respective files are listed. That is to say, the fingerprint generating means 101a generates the file name list L in which the file names of the files configuring the file set 1041. Moreover, the fingerprint generating means 101a generates the fingerprint FP1 for the file set 1041 based on the metadata of the respective files included in the file set 1041, and records the generated fingerprint FP1 as a fingerprint at a reference moment into the fingerprint storing means 102. Besides, the fingerprint generating means 101a also records the file name list L into the fingerprint storing means 102.

The fingerprint storing means 102 is a recording medium on which the fingerprint FP1 at the reference moment and the file name list are recorded by the fingerprint generating means 101a, and the fingerprint storing means 102 includes, for example, a portable nonvolatile memory such as a compact disk and a USB memory, a file-sharing server on a network, and the like.

The differential data extracting means 105, in response to a differential data extraction instruction inputted by the user, extracts all files (metadata and file contents) on the secondary storage device 104 that have been changed or added at or after the reference moment as differential data, and records into the differential data storing means 106.

The differential data storing means 106 is a recording medium on which the differential data is recorded by the differential data extracting means 105, and the differential data storing means 106 includes, for example, a portable nonvolatile memory such as a compact disk and a USB memory, a file-sharing server on a network, and the like. The differential data storing means 106 and the fingerprint storing means 102 may be the same medium.

The fingerprint generating means 101a and the differential data extracting means 105 can be realized by causing a computer to load a program for causing the computer to function as the fingerprint generating means 101a and the differential data extracting means 105, and causing the computer to execute an operation according to the program.

Further, the computer system 2a has an inconsistency detecting means 103a, a fingerprint generating means 201, a secondary storage device 204, and a differential data applying means 205.

The inconsistency detecting means 103a, in response to a consistency verification instruction inputted by the user, outputs a fingerprint generation instruction including the file name list recorded in the fingerprint storing means 102 to the fingerprint generating means 201. Then, the inconsistency detecting means 103a compares the fingerprint FP2 at a verification moment returned by the fingerprint generating means 201 in response to this instruction, with the fingerprint FP1 at the reference moment recorded in the fingerprint storing means 102, and determines whether the fingerprints coincide or not.

The fingerprint generating means 201, in response to the fingerprint generation instruction from the inconsistency detecting means 103a, generates the fingerprint FP2 for a file set 2041 whose components are files specified by a file name list in the above instruction, based on the metadata of the respective files configuring the file set 2041. Then, the fingerprint generating means 201 returns the generated fingerprint FP2 to the inconsistency detecting means 103a.

When the result of the comparison by the inconsistency detecting means 103a is “coincide,” the differential data applying means 205 updates or adds the corresponding file on the secondary storage device 204 with reference to the differential data stored in the differential data storing means 106.

The inconsistency detecting means 103a, the fingerprint generating means 201 and the differential data applying means 205 can be realized by causing a computer to load a program for causing the computer to function as the inconsistency detecting means 103, the fingerprint generating means 201 and the differential data applying means 205, and causing the computer to execute an operation according to the program.

### Description of Operation of Second Exemplary Embodiment

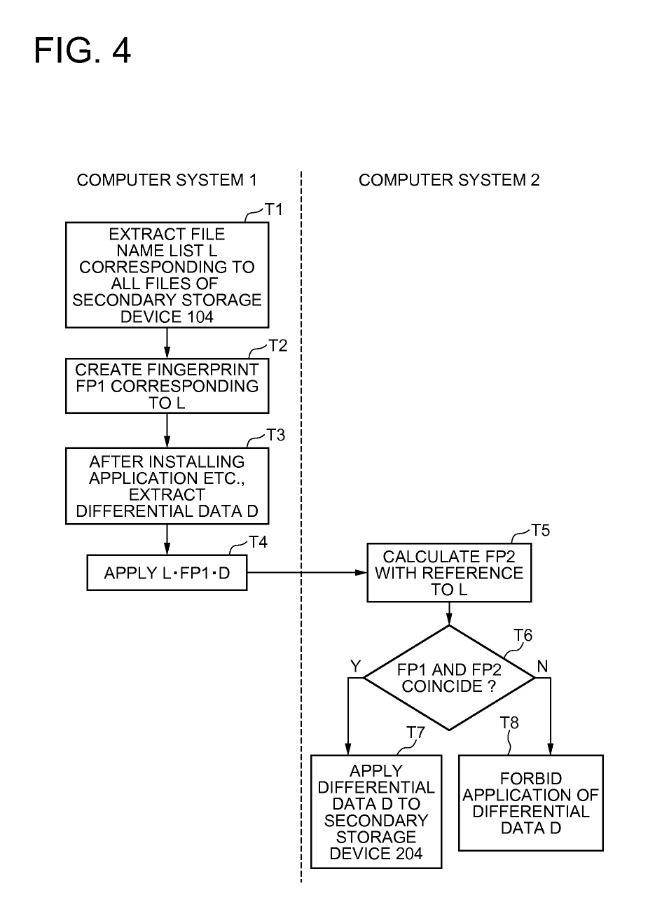

Next, an entire operation of this exemplary embodiment will be described in detail with reference to FIG. 3 and a flowchart of FIG. 4.

Firstly, in response to a fingerprint generation instruction inputted by the user, the fingerprint generating means 101a of the computer system la scans the metadata of all files stored in the secondary storage device 104, and generates the file name list L (step T1 of FIG. 4). Then, with reference to the file name list L, the fingerprint generating means 101a generates the fingerprint FP1 for the file set 1041 including files whose names are listed in the file name list L as components, and records the generated fingerprint FP1 and the file name list L into the fingerprint storing means 102 (step T2), in a like manner as in step S2 and step S3 in the first exemplary embodiment. In this exemplary embodiment, the fingerprint FP1 for the file set 1041 whose components are all of the files stored in the secondary storage device 104 is generated, but the fingerprint FP1 for a file set whose components are files satisfying a condition inputted by the user may be generated as in the first exemplary embodiment. However, in this case, there is a need to record the condition inputted by the user into the fingerprint storing means 102 as in the first exemplary embodiment. Moreover, a file name list in which the file names of all or part of the files stored in the secondary storage device 104 are listed may be inputted as the condition inputted by the user.

After that, the user of the computer system la executes update of the OS, installation of a new application, and so on, and then inputs a differential data extraction instruction to the differential data extracting means 105. Consequently, the differential data extracting means 105 creates differential data D including update data and additional data such as binary data of the update file of the OS and the installed application, and stores into the differential data storing means 106 (step T3). At this moment, the differential data extracting means 105 identifies a file corresponding to update data and additional data that should be extracted as differential data, based on that timestamp information included in the metadata on the secondary storage device 104 is at or after the reference moment.

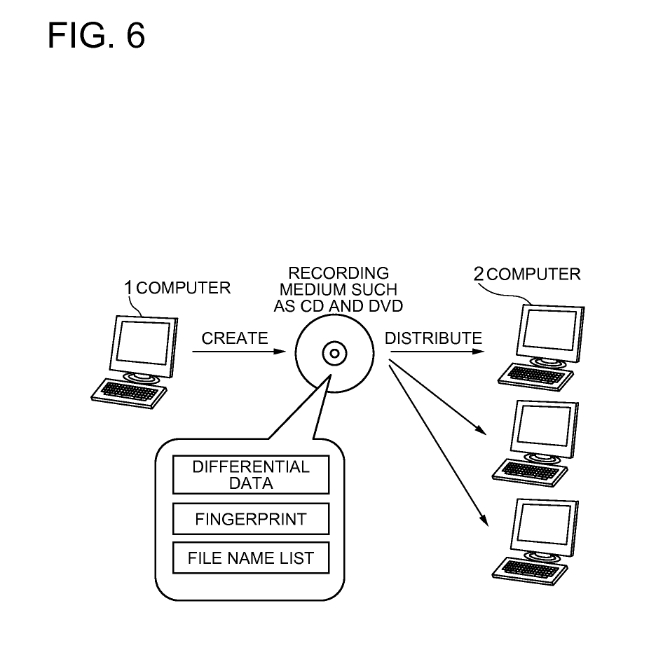

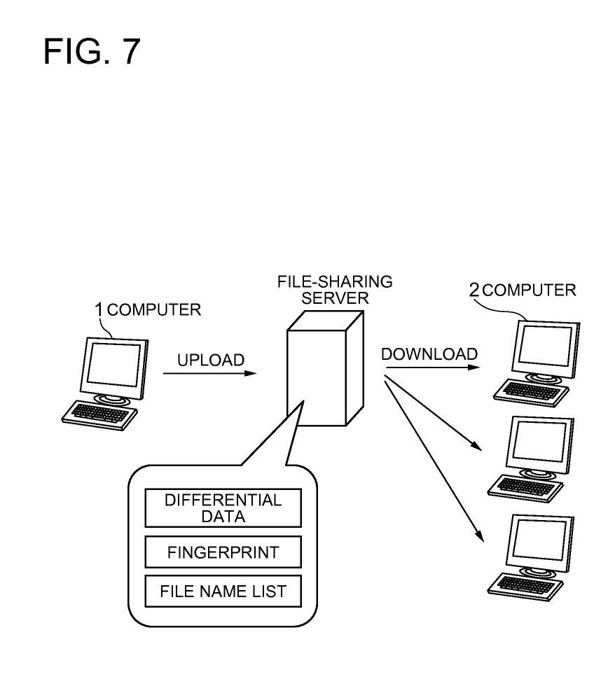

After steps T1 to T3 are executed, the user of the computer system 1a distributes the fingerprint storing means 102 and the differential data storing means 106 to another computer (step T4). A distribution method may be any method that allows another computer system to refer to the file name list L, the fingerprint FP1 at the reference moment, and the differential data D. As a specific example, it is possible to configure the fingerprint storing means 102 and the differential data storing means 106 by a portable nonvolatile memory medium such as a compact disk and a USB memory and distribute the medium or a copy thereof (refer to FIG. 6). Further, it is also possible to configure the fingerprint storing means 106 and the differential data storing means 106 by a file-sharing server on a network or the like and share the file-sharing server device with another computer (refer to FIG. 7).

Next, the user of the computer system 2a connects the distributed fingerprint storing means 102 and differential data storing means 106 to the computer system 2a, and thereafter inputs a consistency verification instruction to the inconsistency detecting means 103a. Consequently, the inconsistency detecting means 103a retrieves the file name list L recorded in the fingerprint storing means 102, and outputs a fingerprint generation instruction including the file name list L to the fingerprint generating means 201. Upon acceptance of the fingerprint generation instruction, the fingerprint generating means 201 executes an operation like the operation at step S4 in the first exemplary embodiment mentioned above, and generates the fingerprint FP2 for the file set 2041 including files whose names are listed in the file name list L as components among the files recorded in the secondary storage device 204. Then, the fingerprint generating means 201 returns the generated fingerprint FP2 as a fingerprint at a verification moment to the inconsistency detecting means 103a (step T5).

When the fingerprint FP2 is returned from the fingerprint generating means 201, the inconsistency detecting means 103a compares the fingerprint FP2 with the fingerprint FP1 at the reference moment recorded in the fingerprint storing means 102, and determines whether the fingerprints coincide or not (step T6).

After that, when the inconsistency detecting means 103a determines that the fingerprints FP1 and FP2 coincide, the differential data applying means 205 writes the differential data D stored in the differential data storing means 106 to the secondary storage device 204, and executes update of the existing file or addition of a new file (step T7). At this moment, the inconsistency detecting means 103a may inform the user that the fingerprints FP1 and FP2 coincide and the user may instruct the differential data applying means 205 to apply the differential data again. Alternatively, the inconsistency detecting means 103a may output an application instruction signal to the differential data applying means 205.

On the other hand, when determining that the fingerprints FP1 and FP2 do not coincide, the inconsistency detecting means 103a informs the user that a necessary condition for enabling safe application of differential data, “consistency of a target file set to which differential data is applied,” is not satisfied, and forbids application of the differential data (step T8).

Effect of Second Exemplary Embodiment

According to this exemplary embodiment, because it is possible to preliminarily and rapidly detect a fault like inconsistency between an application and a library, which may occur at the time of application of the differential data generated in the computer system la to the computer system 2a, it is possible to distribute software more safely while keeping performance degradation to a minimum. This is because at the time of application of the differential data D to the computer system 2a, the fingerprint FP1 generated by the fingerprint generating means 101a at the reference moment and the fingerprint FP2 generated by the fingerprint generating means 101a at the verification moment are compared and, when the fingerprints do not coincide, application of the differential data D is forbidden.

One example of a conventional software distribution method including an inconsistency detection step is a software distribution method based on a “version number” disclosed in Japanese Unexamined Patent Application Publication No. 11-85528. However, in this method, it is required to connect a software distribution server to all computer systems for the purpose of measurement of version numbers and always supervise update of files in all of the computer systems. On the contrary, according to the second exemplary embodiment of the present invention, it is not necessary to install a special software distribution server, and therefore, it is possible to reduce the costs of introduction and operation of the whole distribution system. Moreover, because it is not necessary to supervise update of files in the computer system, it is possible to solve the problem of performance degradation in a routine computer system operation.

### Third Exemplary Embodiment of Present Invention

Next, a third exemplary embodiment of the present invention will be described in detail. In the second exemplary embodiment described above, under a condition that the file set 1041 of the computer system as a source of distribution of the differential data D and the file set 2041 of the computer system as a destination of application (a destination of distribution) of the differential data D are consistent, the differential data D is applied to the application destination computer system. On the other hand, in this exemplary embodiment, it is determined whether to apply the differential data also in consideration of an application condition that is unique to the application destination computer system.

Here, the application condition is a condition that a file included in the differential data D does not compete with an application included only in a computer system as a destination of application of the differential data D. For example, in a case that an application having already been installed in the application destination computer system is compatible with only a library of a specific version and the library of a different version is included in the differential data D, there is a fear that the application does not operate because the differential data D is applied. Here, by designating a specific version of the abovementioned library as the application condition and, in a case that the differential data does not agree with this application condition, aborting application of the differential data, it is possible to prevent occurrence of the abovementioned problem.

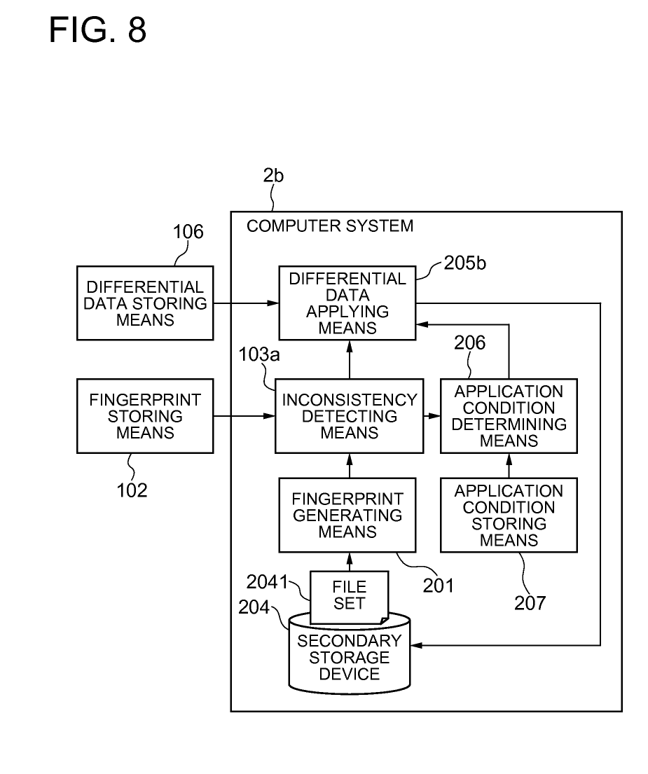

This exemplary embodiment is realized by using a computer system 2b shown in FIG. 8 instead of the computer system 2a in the system shown in FIG. 3. The computer system 2b is different from the computer system 2a shown in FIG. 3 in including a differential data applying means 205b instead of the differential data applying means 205, including an application condition determining means 206, and including an application condition storing means 207.

In the application condition storing means 207, an application condition that is unique to the computer system 2b is recorded. The application condition determining means 206 determines whether all files in the differential data D recorded in the differential data storing means 106 satisfy the application condition recorded in the application condition storing means 207. When the inconsistency detecting means 103a determines that the fingerprints FP1 and FP2 coincide and also the application condition determining means 206 determines that the differential data D agrees with the application condition, the differential data applying means 205b applies the differential data D to the secondary storage device 204.

The inconsistency detecting means 103a, the fingerprint generating means 201, the differential data applying means 205b and the application condition determining means 206 can be realized by a computer and, for example, are realized by a computer in the following manner. A disk on which a program for causing a computer to function as the inconsistency detecting means 103a, the fingerprint generating means 201, the differential data applying means 205b and the application condition determining means 206 is recorded, a semiconductor memory, and another recording medium are prepared, and the computer is caused to retrieve the program. The computer controls its own operation in accordance with the retrieved program, thereby realizing the inconsistency detecting means 103a, the fingerprint generating means 201, the differential data applying means 205b and the application condition determining means 206 on the computer itself.

### Description of Operation of Third Exemplary Embodiment

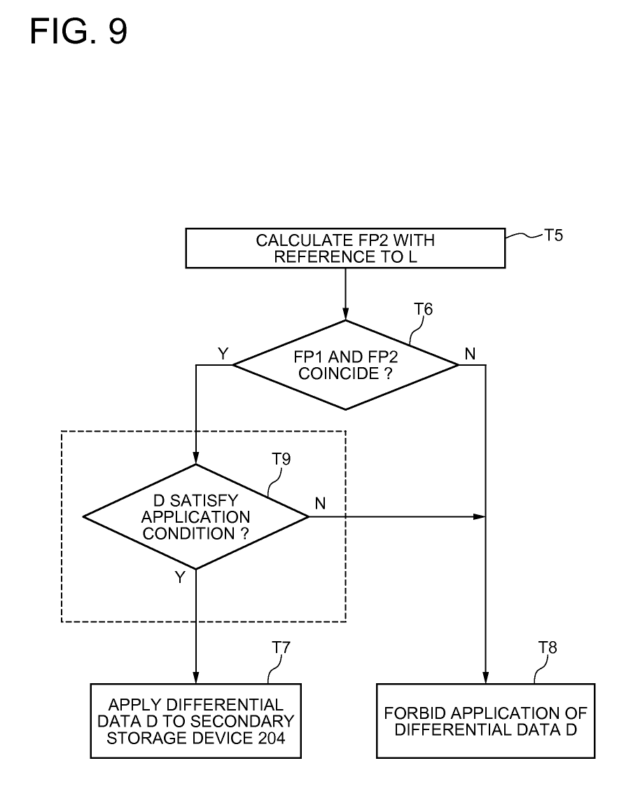

Next, an operation of this exemplary embodiment will be described. Because an operation of the computer system la is like the operation in the second exemplary embodiment described above, only an operation of the computer system 2b will be described here with reference to a flowchart of FIG. 9

The user of the computer system 2b connects the distributed fingerprint storing means 102 and differential data storing means 106 to the computer system 2b, and thereafter inputs a consistency verification instruction to the inconsistency detecting means 103a. Consequently, the inconsistency detecting means 103a generates the fingerprint FP2 at the verification moment by using the fingerprint generating means 201 (step T5).

After that, the inconsistency detecting means 103a compares the fingerprint FP2 generated at step T5 with the fingerprint FP1 at the reference moment recorded in the fingerprint storing means 102 (step T6).

Then, in a case that the fingerprints FP1 and FP2 do not coincide, the inconsistency detecting means 103a informs the user of “inconsistent,” and forbids application of the differential data D (step T8).

On the contrary, in a case that the fingerprints FP1 and FP2 coincide, the application condition determining means 206 determines with reference to the differential data D in the differential data storing means 106 whether each file included in the differential data D satisfies the application condition recorded in the application condition storing means 207 (step T9). When the file satisfies, the application condition determining means 206 applies the differential data D to the secondary storing device 204 (step T7) and when the file does not satisfy, the application condition determining means 206 forbids application of the differential data D (step T8).

As the “application condition,” any condition relating to the metadata and content of a file included in the differential data D, such as the upper limit of a file size, may be used, but it is desirable to use a “file dependency relation unique to the computer system 2b” as one favorable example.

The file dependency relation is a condition of a dependent file requested by a file that does not exist in the computer system 1a and exists only in the computer system 2b (referred to as a unique file hereinafter). For example, in a case that a unique file is an execution binary file of a certain application, the abovementioned condition is a condition relating to metadata, such as version information and timestamp information, for identifying a dependent file of a library, a driver and so on necessary for execution of the file.

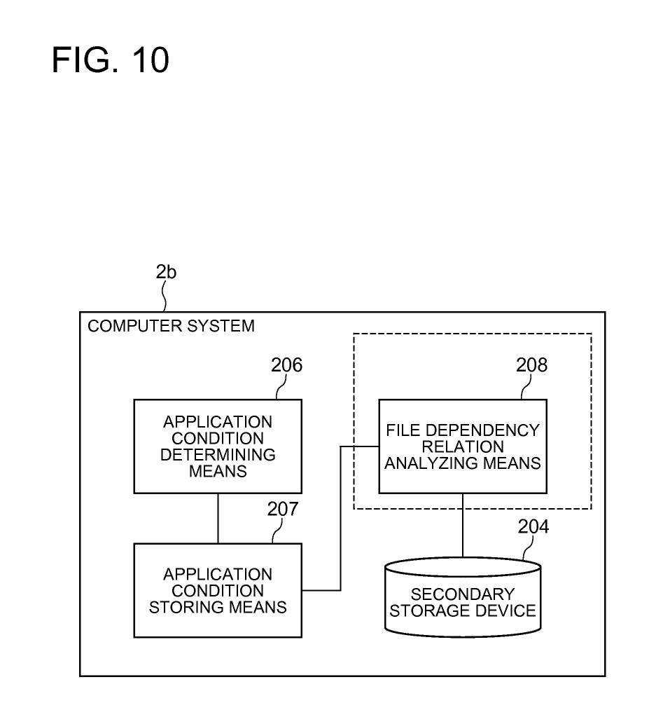

Because it is difficult in general for the user to directly input a file dependency relation, the computer system 2b may be further provided with a file dependency relation analyzing means 208 as shown in FIG. 10. The file dependency relation analyzing means 208 can also be realized by program control of the computer.

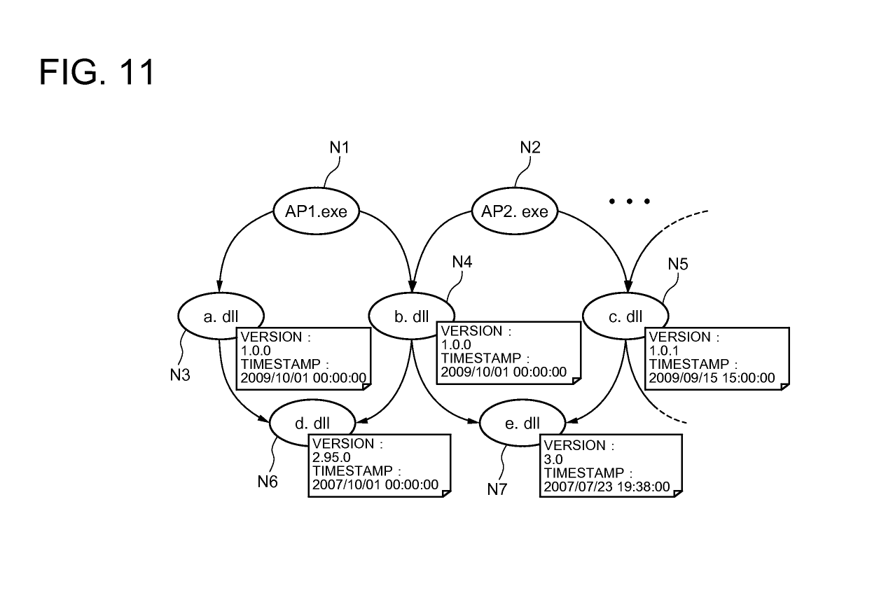

Regarding all execution binary files stored in the secondary storing device 204, the file dependency relation analyzing means 208 generates a directed graph equivalent to a file dependency relation as shown in FIG. 11, by tracing dependent file information stored in a specific region of the content portion of the file, and records into the application condition storing means 207. In the directed graph of FIG. 11, each of nodes N1, N2, . . . , N7, . . . correspond to one file, and a string within the node represents the file name of a corresponding file. Moreover, start nodes N1, N2, . . . correspond to execution binary files, and nodes N3, N4, . . . , N7, . . . each having an incoming edge correspond to dependent files necessary for execution of the execution binary files. The nodes N3, N4, . . . , N7, . . . are each provided with a “version stamp and timestamp” that is an attribute of a corresponding dependent file. The file dependency relation analyzing means 208 acquires this attribute “version and timestamp” from the metadata of the file.

The application condition determining means 206 determines whether the differential data D can be applied or not by using the directed graph shown in FIG. 11. To be specific, the application condition determining means 206 identifies start nodes corresponding to execution binary files that are not included in the differential data D among the start nodes of the directed graph. Then, the application condition determining means 206 focuses on one of the identified start nodes, and determines whether a node corresponding to a dependent file included in the differential data D exists in nodes that are accessible from the focused node based on, for example, a file name. In a case that such a node exists, the application condition determining means 206 compares an attribute given to the node with an attribute of the corresponding file in the differential data D and, when the attributes do not coincide, forbids application of the differential data D. On the contrary, when the attributes coincide, the application condition determining means 206 checks whether a start node that has not been focused yet exists in the identified start nodes. In a case that a node that has not been focused yet does not exist, the application condition determining means 206 permits application of the differential data D. On the contrary, in a case that a node that has not been focused yet exists, the application condition determining means 206 focuses on one of the nodes that have not been focused yet, and executes the same process as the abovementioned process.

### Effect of Third Exemplary Embodiment

According to this exemplary embodiment, it is possible to prevent occurrence of a case that an application corresponding to a unique file that is unique to the computer system 2b does not operate, which may occur because the differential data D is applied to the computer system 2b. This is because this exemplary embodiment is provided with the application condition determining means 206 for determining whether to permit application of differential data based on an attribute that should be satisfied by a dependent file on which the unique file unique to the computer system 2b depends recorded in the application condition storing means 207 and an attribute included in the differential data D.

Further, according to this exemplary embodiment, it is possible to prevent occurrence of the case that an application corresponding to a unique file that is unique to the computer system 2b does not operate, without placing a burden on the user. This is because this exemplary embodiment is provided with the file dependency relation analyzing means 208 for generating a directed graph which represents a dependency relation between an execution binary file and a dependent file and in which one node corresponds to one file and each node is provided with an attribute of the file corresponding to the node, by tracing dependent file information stored in a specific region of the content portion of the file, and the application condition determining means 206 for determining whether to apply the differential data D by using the directed graph generated by the file dependency relation analyzing means 208.

### Fourth Exemplary Embodiment of Present Invention

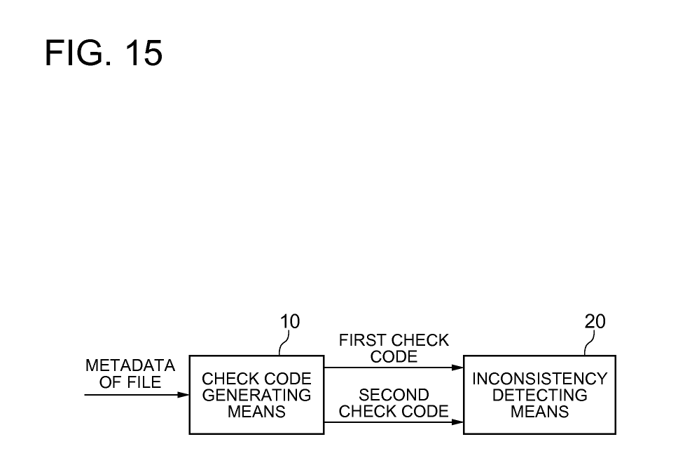

Next, a fourth exemplary embodiment of the present invention will be described. With reference to FIG. 15, a file set consistency verification system according to this exemplary embodiment is equipped with a check code generating means 10 and an inconsistency verifying means 20.

The check code generating means 10, regarding a first file set configured by files satisfying a designated condition, generates a first check code uniquely representing a characteristic of the first file set based on metadata of the files belonging to the first file set at a reference moment. The first check code changes when the first file set is changed. Moreover, the check code generating means 10, regarding a second file set configured by files satisfying the condition, generates a second check code uniquely representing a characteristic of the second file set based on metadata of the files belonging to the second file set.

The inconsistency detecting means 10 compares the first check code and the second check code and, based on inconsistency between the check codes, detects inconsistency between the first file set and the second file set.

According to this configuration, even when a file set to be subjected to consistency verification is large-size, it is possible to shorten a time required for a process of verifying consistency of the file set without adversely affecting on the file output performance in a routine operation of a computer system. This is because consistency of a file set is verified by using a check code generated based on metadata of a file configuring the file set.

In this case, it is preferred that the file set consistency verification system includes a storage device storing files and metadata thereof, and the check code generating means generates the first check code and the second check code at the reference moment and a verification moment, respectively, based on metadata of files satisfying the condition among the metadata stored in the storage device.

Further, it is preferred that the file set consistency verification system includes:

first and second storage devices storing files and metadata thereof;

a differential data storing means;

a differential data extracting means for recording a file updated at and after the reference moment among the files stored in the first storage device into the differential data storing means; and

a differential data applying means for applying differential data recorded in the differential data storing means to the second storage device, and:

the check code generating means generates the first check code based on metadata of files satisfying the condition among the files stored in the first storage device at the reference moment, and generates the second check code based on metadata of files satisfying the condition among the files stored in the second storage device at the verification moment; and

the differential data applying means applies the differential data to the second storage device only when the inconsistency between the first file set and the second file set is not detected by the inconsistency detecting means.

According to this, because it is possible to preliminarily and rapidly detect a fault such as inconsistency between an application and a library, which may occur when a file (differential data) updated at and after a reference moment within a file stored in a first storage device of a certain computer system, it is possible to distribute software more safely while holding performance degradation to a minimum.

Further, it is desirable that the file set consistency verification system includes:

an application condition storing means for storing an attribute that a dependent file on which a unique file unique to the second storage device depends should satisfy; and

an application condition determining means for determining whether to permit application of the differential data based on an attribute of a file included in the differential data recorded in the differential data storing means and the attribute recorded in the application condition storing means, and

the differential data applying means applies the differential data to the second storage device only when the inconsistency between the first file set and the second file set is not detected by the inconsistency detecting means and also the application of the differential data is permitted by the application condition determining means.

According to this, it is possible to prevent occurrence of a case that an application corresponding to a unique file that is unique to another computer system does not operate, which may occur when a file (differential data) updated at and after a reference moment among files stored in a first storage device of one computer system is applied to a second storage system of the other computer system. This is because the system is provided with the application condition determining means for determining whether to permit application of differential data based on an attribute satisfied by a dependent file on which the unique file unique to the other computer system depends recorded in the application condition storing means and an attribute included in the differential data.

Further, it is preferred that the file set consistency verification system includes:

an application condition storing means;

a file dependency relation analyzing means for: generating a directed graph which represents a dependency relation between an execution binary file recorded in the second storage device and a dependent file that the execution binary file depends, and in which one node corresponds to one file and each node is provided with an attribute of a corresponding file, by tracing dependent file information stored in specific regions of content portions of the files; and recording the generated directed graph into the application condition storing means; and

an application condition determining means for determining whether to permit application of the differential data based on an attribute of a file included in the differential data recorded in the differential data storing means and the directed graph recorded in the application condition storing means, and

the differential data applying means applies the differential data to the second storage device only when the inconsistency between the first file set and the second file set is not detected by the inconsistency detecting means and also the application of the differential data is permitted by the application condition determining means.

According to this, the system is provided with the file dependency relation analyzing means for generating a directed graph which represents a dependency relation between an execution binary file and a dependent file and in which one node corresponds to one file and each node is provided with an attribute of the file corresponding to the node, by tracing dependent file information stored in a specific region of the content portion of a file, and the application condition determining means for determining whether to apply the differential data by using the directed graph generated by the file dependency relation analyzing means. Therefore, it is possible, without placing a burden on the user, to prevent occurrence of a case that an application corresponding to a unique file unique to a computer system does not operate in the computer system as a destination of allocation of differential data.

Further, it is preferred that in the file set consistency verification system, the check code is an appearance frequency distribution of a certain attribute among attributes of metadata of the files satisfying the condition. According to this, it is possible to decrease the size of the check code, and consequently, it is possible to shorten a time required for a check code comparison process.

Further, it is preferred that in the file set consistency verification system, the check code is a hash chain regarding at least a certain attribute among attributes of metadata of the files satisfying the condition. According to this, the check code becomes fixed-length, and consequently, regardless of the number of files or the size of files included in a file set to be subjected to verification, it is possible to make a time required for the check code comparison process constant.

Further, a file set consistency verification method of another exemplary embodiment of the present invention includes:

regarding a first file set configured by files satisfying a designated condition, generating a first check code uniquely representing a characteristic of the first file set based on metadata of the files belonging to the first file set at a reference moment, by a check code generating means;

regarding a second file set configured by files satisfying the condition, generating a second check code uniquely representing a characteristic of the second file set based on metadata of the files belonging to the second file set at a verification moment at or after the reference moment, by the check code generating means; and

detecting inconsistency between the first file set and the second file set based on inconsistency between the first check code and the second check code, by an inconsistency detecting means.

According to this, even when the size of a file set to be subjected to consistency verification is large, it is possible to shorten a time required for a process of verifying consistency of the file set without adversely affecting on the file output performance in a routine operation of a computer system. This is because consistency of a file set is verified by using a check code generated based on metadata of a file configuring the file set.

Further, a computer-readable recording medium of another exemplary embodiment is a computer-readable recording medium storing a file set consistency verification program for causing a computer to function as a file set consistency verification system, and the program includes instructions for causing the computer function as:

a check code generating means for, regarding a first file set configured by files satisfying a designated condition, generating a first check code uniquely representing a characteristic of the first file set based on metadata of the files belonging to the first file set at a reference moment and, regarding a second file set configured by files satisfying the condition, generating a second check code uniquely representing a characteristic of the second file set based on metadata of the files belonging to the second file set at a verification moment at or after the reference moment; and

an inconsistency detecting means for comparing the first check code and the second check code and, based on inconsistency between the check codes, detecting inconsistency between the first file set and the second file set.

According to this, even when the size of a file set to be subjected to consistency verification is large, it is possible to shorten a time required for a process of verifying consistency of the file set without adversely affecting on the file output performance in a routine operation of a computer system. This is because consistency of a file set is verified by using a check code generated based on metadata of a file configuring the file set.

Although the present invention has been described above with reference to the respective exemplary embodiments, the present invention is not limited to the aforementioned exemplary embodiments. The configuration and details of the present invention can be altered in various manners that can be understood by those skilled in the art within the scope of the present invention.

The present invention is based upon and claims the benefit of priority from Japanese patent application No. 2010-010671, filed on Jan. 21, 2010, the disclosure of which is incorporated herein in its entirety by reference.

### INDUSTRIAL APPLICABILITY

According to the present invention, it is possible to apply to a security system use such as falsification check of important data. Moreover, it is also possible to apply to a use such as a preliminary check of a fault probability in a backup system and a software distribution system.

### DESCRIPTION OF NUMERALS

1, 1a, 2a, 2b computer system

101, 101a fingerprint generating means

102 fingerprint storing means

103, 103a inconsistency detecting means

104 secondary storage device

105 differential data extracting means

106 differential data storing means

201 fingerprint generating means

204 secondary storage device

205, 205b differential data applying means

206 application condition determining means

207 application condition storing means

208 file dependency relation analyzing means

1041 file set

2041 file set

10 check code generating means

20 inconsistency detecting means

1. A file set consistency verification system, comprising:
a check code generating unit for, regarding a first file set configured by files satisfying a designated condition, generating a first check code uniquely representing a characteristic of the first file set based on metadata of the files belonging to the first file set at a reference moment and, regarding a second file set configured by files satisfying the condition, generating a second check code uniquely representing a characteristic of the second file set based on metadata of the files belonging to the second file set at a verification moment at or after the reference moment; and
an inconsistency detecting unit for comparing the first check code and the second check code and, based on inconsistency between the check codes, detecting inconsistency between the first file set and the second file set.

2. The file set consistency verification system according to claim 1, comprising a storage device storing files and metadata thereof,
wherein the check code generating unit generates the first check code and the second check code at the reference moment and the verification moment, respectively, based on metadata of files satisfying the condition among the metadata stored in the storage device.

3. The file set consistency verification system according to claim 1, comprising:
first and second storage devices storing files and metadata thereof;
a differential data storing unit;
a differential data extracting unit for recording a file updated at and after the reference moment among the files stored in the first storage device into the differential data storing unit; and
a differential data applying unit for applying differential data recorded in the differential data storing unit to the second storage device, wherein:
the check code generating unit generates the first check code based on metadata of files satisfying the condition among the files stored in the first storage device at the reference moment, and generates the second check code based on metadata of files satisfying the condition among the files stored in the second storage device at the verification moment; and
the differential data applying unit applies the differential data to the second storage device only when the inconsistency between the first file set and the second file set is not detected by the inconsistency detecting unit.

4. The file set consistency verification system according to claim 3, comprising:
an application condition storing unit for storing an attribute that a dependent file on which a unique file unique to the second storage device depends should satisfy; and
an application condition determining unit for determining whether to permit application of the differential data based on an attribute of a file included in the differential data recorded in the differential data storing unit and the attribute recorded in the application condition storing unit,
wherein the differential data applying unit applies the differential data to the second storage device only when the inconsistency between the first file set and the second file set is not detected by the inconsistency detecting unit and also the application of the differential data is permitted by the application condition determining unit.

5. The file set consistency verification system according to claim 3, comprising:
an application condition storing unit;
a file dependency relation analyzing unit for: generating a directed graph which represents a dependency relation between an execution binary file recorded in the second storage device and a dependent file that the execution binary file depends, and in which one node corresponds to one file and each node is provided with an attribute of a corresponding file, by tracing dependent file information stored in specific regions of content portions of the files; and recording the generated directed graph into the application condition storing unit; and
an application condition determining unit for determining whether to permit application of the differential data based on an attribute of a file included in the differential data recorded in the differential data storing unit and the directed graph recorded in the application condition storing unit,
wherein the differential data applying unit applies the differential data to the second storage device only when the inconsistency between the first file set and the second file set is not detected by the inconsistency detecting unit and also the application of the differential data is permitted by the application condition determining unit.

6. The file set consistency verification system according to claim 1, wherein the check code is an appearance frequency distribution of a certain attribute among attributes of metadata of the files satisfying the condition.

7. The file set consistency verification system according to claim 1, wherein the check code is a hash chain regarding at least a certain attribute among attributes of metadata of the files satisfying the condition.

8. A file set consistency verification method, comprising:
regarding a first file set configured by files satisfying a designated condition, generating a first check code uniquely representing a characteristic of the first file set based on metadata of the files belonging to the first file set at a reference moment, by a check code generating unit;
regarding a second file set configured by files satisfying the condition, generating a second check code uniquely representing a characteristic of the second file set based on metadata of the files belonging to the second file set at a verification moment at or after the reference moment, by the check code generating unit; and
detecting inconsistency between the first file set and the second file set based on inconsistency between the first check code and the second check code, by an inconsistency detecting unit.

9. A computer-readable recording medium storing a file set consistency verification program for causing a computer to function as a file set consistency verification system, the computer-readable recording medium storing the program comprising instructions for causing the computer function as:
a check code generating unit for, regarding a first file set configured by files satisfying a designated condition, generating a first check code uniquely representing a characteristic of the first file set based on metadata of the files belonging to the first file set at a reference moment and, regarding a second file set configured by files satisfying the condition, generating a second check code uniquely representing a characteristic of the second file set based on metadata of the files belonging to the second file set at a verification moment at or after the reference moment; and
an inconsistency detecting unit for comparing the first check code and the second check code and, based on inconsistency between the check codes, detecting inconsistency between the first file set and the second file set.
